(19) United States
(12) Patent Application Publication
(10) Pub. No.: US 2025/0358583 A1
(43) Pub. Date: Nov. 20, 2025

(54) IMMERSIVE AUDIO FADING

(71) Applicant: Dolby Laboratories Licensing Corporation, San Francisco, CA (US)

(72) Inventors: C.Phillip Brown, Castro Valley, CA (US); Michael J. Smithers, Kareela (AU); Douglas E. Mandell, San Francisco, CA (US)

(73) Assignee: Dolby Laboratories Licensing Corporation, San Francisco, CA (US)

(21) Appl. No.: 18/871,618

(22) PCT Filed: Jun. 5, 2023
(86) PCT No.: PCT/US2023/024425

§ 371 Date: Dec. 4, 2024

(30) Foreign Application Priority Data
Jun. 8, 2022 (US) 63350122

(51) Int. Cl. H04S 7/00; H04S 3/00

(52) U.S. Cl. CPC H04S 7/302; H04S 3/008; H04S 7/307; H04S 2400/01; H04S 2400/11; H04S 2400/13

(57) ABSTRACT

Enclosed are embodiments for immersive audio fading. In some embodiments, a method comprises: receiving object-based audio and metadata; rendering the object-based audio into a multichannel audio presentation for a first loudspeaker layout based on the metadata determining a first mix based on the multichannel audio presentation and a second loudspeaker layout associated with the vehicle; generating first loudspeaker signals based on the first mix for playback through loudspeakers in the second loudspeaker layout; receiving input; determining a second mix different from the first mix based on the multichannel audio presentation and the input; and generating second loudspeaker signals based on the second mix for play back through the loudspeakers in the second loudspeaker layout.

### CROSS-REFERENCE TO RELATED APPLICATIONS

This application claims priority to U.S. Provisional Application No. 63/350,122 filed on Jun. 8, 2022, which is incorporated by reference in its entirety.

### TECHNICAL FIELD

This disclosure relates generally to audio processing.

### BACKGROUND

Most vehicles or other listening environments contain loudspeakers for stereo playback from tapes, CDs, or terrestrial and satellite radio. Automotive audio systems, for example, typically include a total of four loudspeakers (a front pair and a rear pair, for the front and rear passengers). FIG. 1 illustrates typical two-row speaker locations for the left side of the vehicle. Corresponding loudspeakers are on the right side of the vehicle. If tweeters are used for the front row, they could be on the dashboard or low on the front side pillars. In more recent years, DVDs introduced multichannel surround sound. Multichannel surround sound introduced a center channel loudspeaker and subwoofer to support the multichannel format, as shown in FIG. 2. Most recently, streaming services such as Spotify® and Tidal® have been integrated into automotive infotainment systems, either directly in the vehicle's hardware (usually known as the “head unit”) or via a smart phone using Bluetooth™ or Apple CarPlay® or Android Auto®.

With immersive audio becoming mainstream in the Cinema and the home, it is natural to assume that immersive audio will also be integrated into automotive audio systems. For example, Dolby Atmos® Music is currently available through various streaming services. Immersive audio is often differentiated from surround sound by the inclusion of overhead audio content with specific height or vertical characteristics, such that the audio content appears to emanate from above a listener position(s) in the listening environment. To support overhead audio, height loudspeakers are often part of the automotive audio system.

Accordingly, a need arises in the vehicle or other listening environment for many loudspeakers, including height loudspeakers, to fully support an immersive audio format. High-end vehicles often contain many loudspeakers, beyond the traditional front and rear stereo pairs. Often, they will include height loudspeakers. It is desirable to introduce fading into spatial audio playback systems that include many different speak layouts including speaker layouts with height channels.

### SUMMARY

Some techniques for fading audio signals are generally cumbersome, inefficient, or ineffective for immersive audio content. For example, some existing techniques rely on manual linear panning between stereo speaker pairs. However, without consideration of the specific spatial cues (e.g., time, amplitude, and frequency processing) incorporated into immersive audio content production and rendering, and the unique physical speaker layouts of immersive audio systems, such techniques cannot facilitate playback of immersive audio content with accurate and consistent spatialization. Thus, existing techniques are ineffective at providing a means for optimizing playback of immersive content, while simultaneously maintaining artistic intent during playback.

Accordingly, the present techniques provides electronic devices with more efficient and effective techniques for fading immersive audio. Such methods optionally complement or replace other methods for processing or optimizing immersive audio content for playback. Such methods and related interfaces reduce the cognitive burden on a user seeking to optimize playback of immersive content for a respective audio system and ultimately, produce a higher quality spatial audio output.

Enclosed are embodiments for immersive audio fading.

In some embodiments, a method comprises: receiving, with at least one processor of an audio system, object-based audio and metadata; rendering, with the at least one processor, the object-based audio into a multichannel audio presentation for a first loudspeaker layout based on the metadata; determining, with the at least one processor, a first mix based on the multichannel audio presentation and a second loudspeaker layout associated with the vehicle; generating, with the at least one processor, first loudspeaker signals based on the first mix for playback through loudspeakers in the second loudspeaker layout; receiving, with the at least one processor, input; determining, with the at least one processor, a second mix different from the first mix based on the multichannel audio presentation and the input; and generating, with the at least one processor, second loudspeaker signals based on the second mix for playback through the loudspeakers in the second loudspeaker layout.

In some embodiments, the multichannel audio presentation includes at least one pair of stereo audio channels.

In some embodiments, the multichannel audio presentation includes at least one pair of stereo channels and at least one low frequency effects (LFE) channel.

In some embodiments, the input includes a fader position of a fader control of the audio system.

In some embodiments, the input includes a fader mode that indicates a preset modification to the multichannel audio presentation.

In some embodiments, the input includes occupancy data that indicates a number of occupants in the vehicle and their seating locations in the interior of the vehicle.

In some embodiments, the vehicle interior is divided into two or more zones and the second mix is determined based at least in part on the two or more zones.

In some embodiments, the second mix applies a gain to at least one channel of the multichannel audio presentation.

In some embodiments, the gain is included in a set of gains that maps channels in the multichannel audio presentation to the loudspeakers in the second loudspeaker layout.

In some embodiments, the multichannel audio presentation includes more channels than loudspeakers in the second loudspeaker layout.

In some embodiments the second loudspeaker layout includes left/right front loudspeakers and left/right back loudspeakers, and the multichannel audio presentation includes left/right/center loudspeakers, left/right middle loudspeakers, and left/right back loudspeakers.

In some embodiments, the second loudspeaker layout further includes at least one of: left/right front height loudspeakers and left/right back height loudspeakers.

In some embodiments, the number of channels in the multichannel audio presentation is equal to the number of loudspeakers in the second loudspeaker layout.

In some embodiments, the second loudspeaker layout and the multichannel audio presentation includes left/right/center loudspeakers, left/right middle loudspeakers, and left/right back loudspeakers.

In some embodiments, the number of channels in the multichannel audio presentation is less than the number of loudspeakers in the second loudspeaker layout.

In some embodiments, the multichannel audio presentation includes a front center channel, and the method further comprises: generating, with the at least one processor, a phantom virtual center from the front center channel; and modifying a predefined spatial position or direction of at least one loudspeaker in the second loudspeaker layout based on the input and the phantom virtual center.

In some embodiments, the multichannel audio presentation includes spatial positions or directions for the loudspeakers in a horizontal plane and a height plane.

In some embodiments, the second mix applies delay or filtering to the second loudspeaker signals.

In some embodiments, determining a second mix based on the multichannel audio presentation and the input further comprises transitioning from a first spatialization mode to a second spatialization mode, the transitioning including re-assigning portions of the first loudspeaker signals to the second loudspeaker signals.

In some embodiments, the re-assigning is based in part on a distance from a listener or listening position associated with the listener, and at least one loudspeaker associated with the second speaker layout.

In some embodiments, the re-assigning moves portions of the first loudspeaker signals

from at least one loudspeaker in the second speaker layout at a first distance from the listener or the listener position to at least one other loudspeaker in the second speaker layout, at a second and greater distance from the listener or the listener position.

In some embodiments, reassigning is performed in accordance with a speaker performance characteristic of at least one loudspeaker in the second speaker layout.

In some embodiments, reassigning includes reassigning portions of the first loudspeaker signals from a center channel associated with the first speaker layout to two or more second loudspeaker signals for non-center channel loudspeaker channels associated with the second speaker layout.

In some embodiments, re-assigning includes attenuating one or more portions of the second loudspeaker signals.

In some embodiments, re-assigning includes: determining a signal coherence value between audio content in portions of the first loudspeaker signals; and applying increased attenuation to the second loudspeaker signals in accordance with the coherence value exceeding one or more coherence threshold values.

In some embodiments, re-assigning includes high pass filtering at least one loudspeaker signal of the second loudspeaker signals corresponding to one or more height channels of the multimedia presentation.

In some embodiments, the multichannel audio presentation includes at least one pair of height audio channels.

In some embodiments, an audio playback system comprises at least one processor, and memory storing instructions that when executed by the at least one processor, cause the at least one processor to perform any of the preceding methods.

In some embodiments, a non-transitory, computer-readable storage medium including instructions thereon that, when execute by at least one processor, causes the at least one processor to perform any of the preceding methods.

Other embodiments disclosed herein are directed to a system, apparatus, and computer-readable medium. The details of the disclosed embodiments are set forth in the accompanying drawings and the description below. Other features, objects and advantages are apparent from the description, drawings and claims.

Particular embodiments disclosed provide advantages over fading applied to traditional stereo/surround audio systems by applying fading to immersive audio systems that include, for example, height speakers.

### DESCRIPTION OF DRAWINGS

FIG. 1 illustrates typical two-row speaker locations for the left side of the vehicle.

FIG. 2 illustrates a typical multichannel automotive audio system with a center channel loudspeaker and subwoofer.

FIG. 3A shows an example of an automobile with an immersive loudspeaker layout.

FIG. 3B shows the same example as in FIG. 3A but the loudspeakers are labeled with common immersive audio channel names.

FIG. 4 is a conceptual drawing of how fading is implemented in a 4 channel (front left/right and rear left/right) automotive audio system in vehicles with two seating rows, according to one or more embodiments.

FIGS. 5A-5C show examples of matrix of gains that are multiplied with the input audio to create the output audio in the vehicle, according to one or more embodiments.

FIG. 6 is a conceptual diagram of how fading is implemented for a three-row vehicle, according to one or more embodiments.

FIG. 7 is a conceptual diagram of an immersive audio presentation in a vehicle with stereo pairs of loudspeakers, according to one or more embodiments.

FIGS. 8A and 8B show example matrix gains for a fader set to ‘center’ and ‘front,’ according to one or more embodiments.

FIG. 9 is a conceptual diagram of an immersive audio presentation in a vehicle with spatial playback capabilities, including a front center loudspeaker and height loudspeakers, according to one or more embodiments.

FIG. 10A shows a fader matrix for a ‘Center’ setting, according to one or more embodiments.

FIG. 10B shows a fader matrix for a fader position intended to be half-way between ‘Center’ and ‘Front,’ according to one or more embodiments.

FIG. 10C shows a fader matrix for a ‘Front’ fader position, according to one or more embodiments.

FIG. 10D shows a fader matrix for a fader position intended to be half-way between ‘Center’ and ‘Rear,’ according to one or more embodiments.

FIG. 10E shows a fader matrix for a ‘Rear’ fader position, according to one or more embodiments.

FIG. 11 illustrates processing a center Presentation channel with a Phantom Virtual Center (PVC) technology, according to one or more embodiments.

FIG. 12 is a flow diagram of spatial audio fading in an automotive audio system, according to one or more embodiments.

FIG. 13 is a block diagram of an example hardware architecture suitable for implementing the systems and methods described in reference to FIGS. 1-12.

In the drawings, specific arrangements or orderings of schematic elements, such as those representing devices, units, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some implementations.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

The same reference symbol used in various drawings indicates like elements.

### DETAILED DESCRIPTION

In the following detailed description, numerous specific details are set forth to provide a thorough understanding of the various described embodiments. It will be apparent to one of ordinary skill in the art that the various described implementations may be practiced without these specific details. In other instances, well-known methods, procedures, components, and circuits, have not been described in detail so as not to unnecessarily obscure aspects of the embodiments. Several features are described hereafter that can each be used independently of one another or with any combination of other features.

Although the disclosed embodiments described below are for automotive audio systems, the embodiments may also be used for any immersive listening environment where fading is needed or desired, or any immersive listening environment where predefined multichannel presentations are to be modified based on user input.

### Nomenclature

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example implementation” and “an example implementation” are to be read as “at least one example implementation.” The term “another implementation” is to be read as “at least one other implementation.” The terms “determined,” “determines,” or “determining” are to be read as obtaining, receiving, computing, calculating, estimating, predicting or deriving. In addition, in the following description and claims, unless defined otherwise, all technical and scientific terms used herein have the same meaning as commonly understood by one of ordinary skills in the art to which this disclosure belongs.

### Example Immersive Loudspeaker Layouts

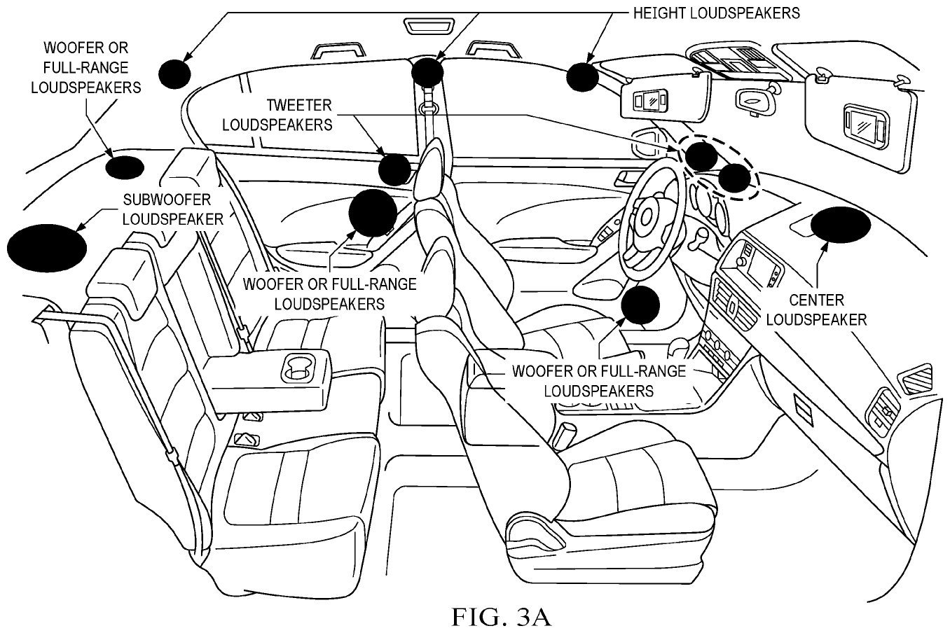

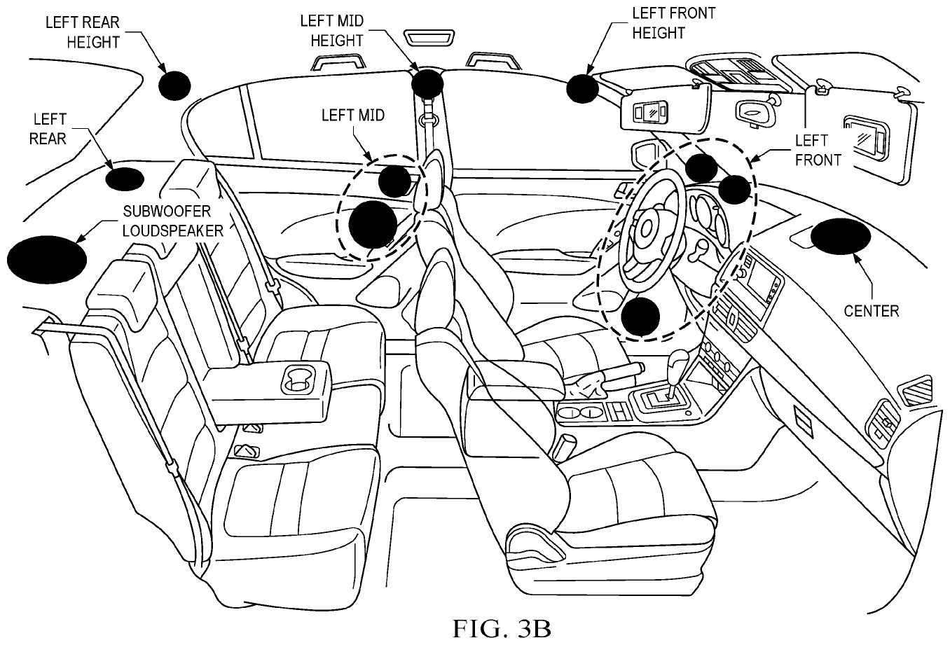

FIG. 3A shows an example of a passenger automobile with an immersive loudspeaker layout. Loudspeakers for the left half and center of the automobile are shown. Corresponding loudspeakers are on the right side of the vehicle. For example, there is a woofer (e.g., mid-bass or sub-bass woofer) or full range loudspeakers behind the backseats (e.g., on the rear deck) or embedded in the front or rear doors of the vehicle, height loudspeakers are placed above all other loudspeakers on or near the ceiling of the interior of the vehicle (e.g., on the pillars separating the windows on the left and right sides of the interior of the vehicle), tweeter loudspeakers and a center loudspeaker are embedded in the dashboard of the vehicle or low on the front windshield pillar as illustrated. FIG. 3B shows the same example as in FIG. 3A, but the loudspeakers are labeled with common immersive audio channel names. Other loudspeaker layouts are also possible.

### Fading

For many years, automotive audio systems had the ability to ‘fade’ or ‘pan’ the audio to the front or rear of the vehicle and to the left and right. From the user perspective, some automotive audio systems provide variable front to back and side to side controls. The fading can be implemented by lowering the levels of specific loudspeaker channel signals. For example, the levels of the ‘rear’ loudspeakers may be turned down relative to the levels of the ‘front’ loudspeakers.

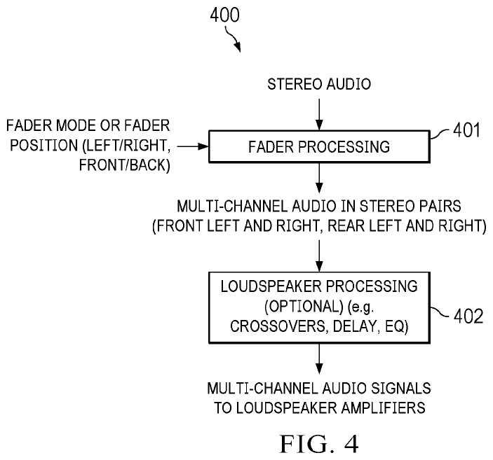

FIG. 4 is a conceptual drawing of how fading is implemented in a 4 channel (front left/right and rear left/right) automotive audio system 400 in vehicles with two seating rows, according to one or more embodiments. Stereo audio from any number of sources including AM/FM radio, CD, MP3 file playback, streaming and satellite radio, enters fader processor 401 which applies a matrix of gains to direct audio to any combination of loudspeakers.

The multichannel audio output (multichannel audio in stereo pairs) by fader processor 401 is passed through loudspeaker processor 402 which typically applies at least one of equalization, crossover filtering (e.g., for multi-way loudspeakers with a woofer and tweeter), speaker protection filtering or level limiting. Loudspeaker processor 402 outputs multichannel audio signals to the loudspeaker amplifiers.

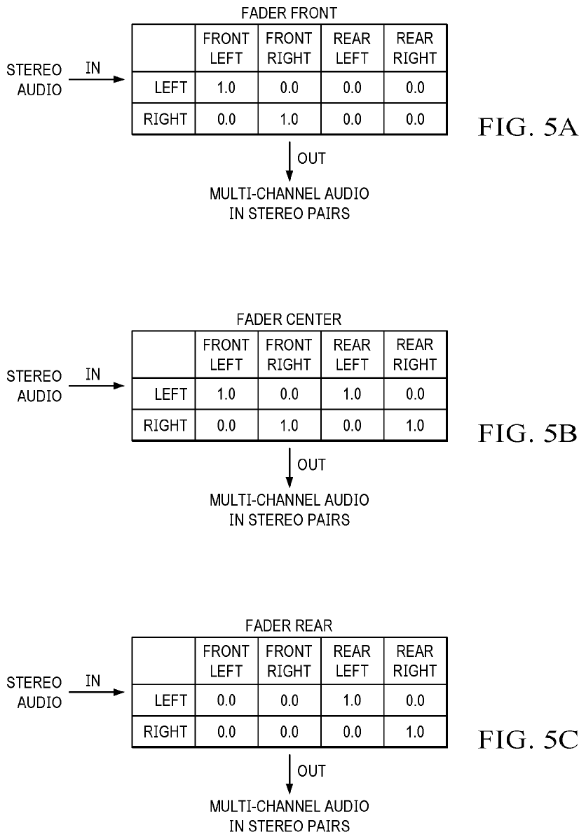

FIGS. 5A-5C show examples of matrix of gains that are multiplied with the input audio to create the output audio in the vehicle, according to one or more embodiments. Referring to FIG. 5A, when the fader is set to ‘front,’ the stereo audio only feeds the front left and front right loudspeaker channels (where “1.0” represents 100% of linear gain and “0.0” represents no linear gain). All other channel gains are set to zero. Referring to FIG. 5B, when the fader is set to ‘center,’ the stereo audio is fed to both rows of loudspeaker channels. Referring to FIG. 5C, when the fader is set to ‘rear,’ the stereo audio only feeds the rear left and rear right loudspeaker channels. Fading of stereo content can be extended for vehicles with additional rows of loud seating, and thus loudspeaker left/right pairs, by extending the matrix to have additional gain values for the additional loudspeaker pairs.

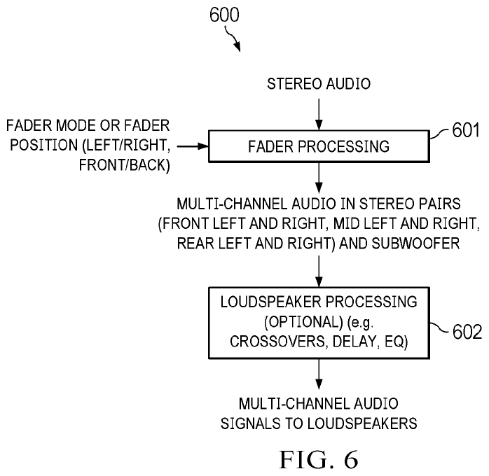

FIG. 6 is a conceptual diagram of how fading is implemented in an automotive audio system 600 for a vehicle including additional speakers (e.g., a three-row vehicle or vehicle with high trim-level audio system), according to one or more embodiments. Stereo audio from any number of sources including AM/FM radio, CD, MP3 file playback, streaming and satellite radio, enters a fader processor 601 which applies a matrix of gains to direct audio to any combination of loudspeakers. The output of fader processor 601 is multichannel audio in stereo pairs (front left and right, mid left and right, rear left and right) plus an optional low frequency effects (LFE) channel (e.g., subwoofer channel).

The multichannel audio output from fader processing 601 (multichannel stereo pairs) is passed through loudspeaker processor 602, which typically applies at least one of equalization, crossover filtering (e.g., for multi-way loudspeakers with a woofer and tweeter), speaker protection filtering or level limiting. Loudspeaker processor 602 typically uses a low-pass filter on the LFE channel to remove mid and high frequencies. Loudspeaker processor 602 outputs multichannel audio signals to the loudspeaker amplifiers.

### Fading Immersive Audio

Both immersive audio content and vehicles with larger numbers of loudspeaker channels (including height channels) present challenges in implementing fading to create quieter zones in the front or rear, while retaining an immersive audio experience for listeners seated closest to the loudspeakers that are still predominantly active. The following disclosure describes methods for fading immersive audio in automotive audio systems for two classes of speaker layouts. Other classes of speaker layouts can also be used.

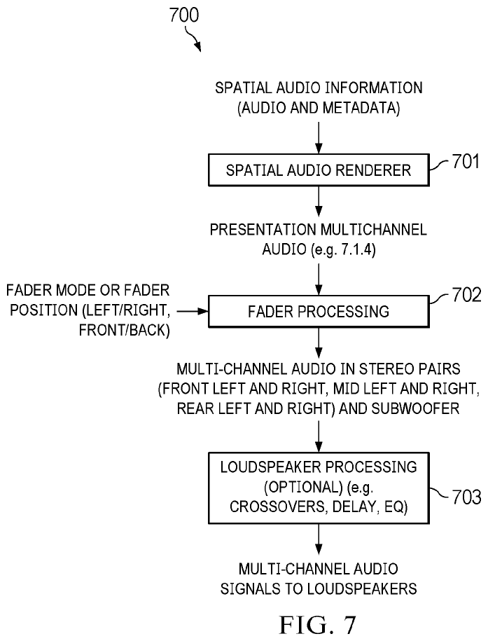

FIG. 7 is a conceptual flow diagram of immersive automotive audio system 700 in a vehicle with stereo pairs of loudspeakers, according to one or more embodiments. Input audio (e.g., spatial audio, in the form of audio stems and metadata), is rendered by a spatial audio renderer 701 into a multichannel audio presentation format such as 5.1.2, 5.1.4, 7.1.4 or any other multichannel audio presentation format in current existence or in the future. The first digit, here 7, refers to the number of channels in the horizontal plane around the listener. The second digit, here 1, refers to the number of LFE (low frequency effects) channels. The third digit, here 4, refers to the number of height channels. Height channels are signals intended for playback in a listening environment from height loudspeakers (see FIG. 3A) mounted and aimed to direct acoustic output toward an intended listening position (directly or via reflection) from above the intended listening position. Note that the number of speakers for playback could be greater than the number of channels (e.g., where the left channel is composed of a tweeter, midrange and woofer that are located in different positions), or it could be fewer than the number of channels (e.g., if the center speaker is missing, the center channel will be panned to the left and right speakers). The presentation typically has defined spatial positions and directions for loudspeakers in the horizontal plane and the height plane relative to a listening position. For example, the 4 height speakers in FIG. 3B are left-front height, right-front height, left-rear height, and right-rear height.

The multichannel presentation is input into fading processor 702, which generates and

outputs multichannel audio in stereo pairs plus an LFE channel. The multichannel audio output by the fading processor 702 is optionally input into loudspeaker processor 703 which outputs loudspeaker signals to additional processing and/or the audio amplifiers of the loudspeakers.

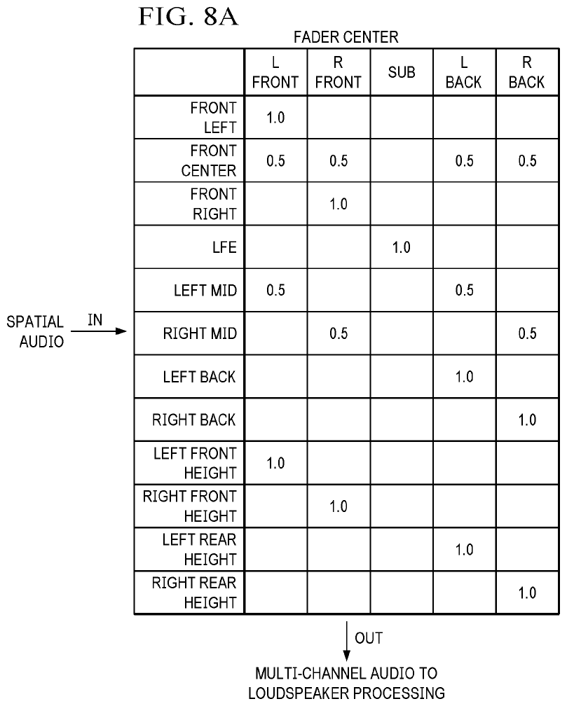

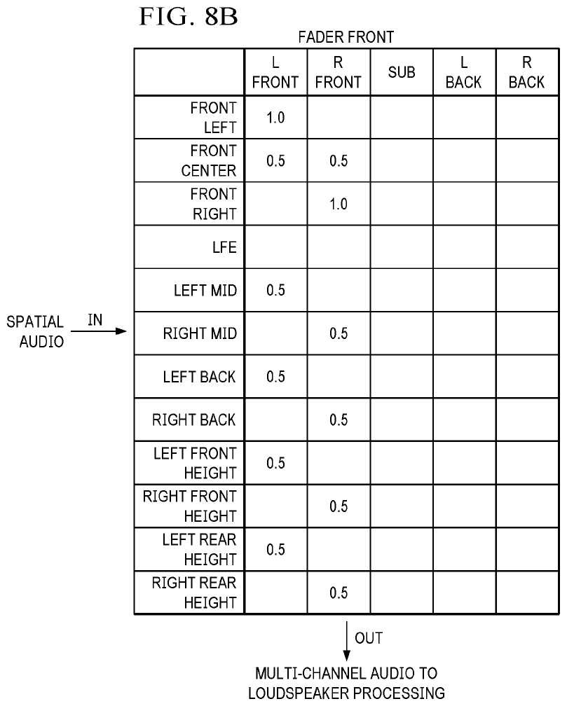

FIGS. 8A and 8B show example matrix gains for fader set to ‘center’ and ‘front,’ according to one or more embodiments. In these figures, empty cells correspond to a linear gain of 0.0. In both examples, the front center input channel is spread to both front left and front right loudspeakers. In FIG. 8B, surround and height channels are attenuated slightly, when mixed to the left front and right front loudspeakers, so as not to overwhelm the immersive audio content from the front left, front center and front right input channels. Note also that the LFE channel is discarded, since the subwoofer is usually in the rear of the vehicle (which, in this example, we are attempting to be quiet) and the LFE signal may be too low in frequency for the capabilities of the front loudspeakers. Alternatively, the LFE could be mixed into woofers that can reproduce the needed low frequencies.

The higher number of input presentation channels, including height channels, means the fader processing has many more input to output combinations and thus a larger matrix. In addition to applying input-to-output gains, it may be beneficial to apply delay and filtering in the fader processor 401, 601, 702. This will be described in more detail in some of the examples that follow.

Referring to the vehicle shown in FIGS. 3A and 3B. The loudspeaker layout shown has a (front) center channel loudspeaker, front, mid and rear loudspeaker left/right pairs, front, mid and rear height loudspeaker left/right pairs, and a rear subwoofer.

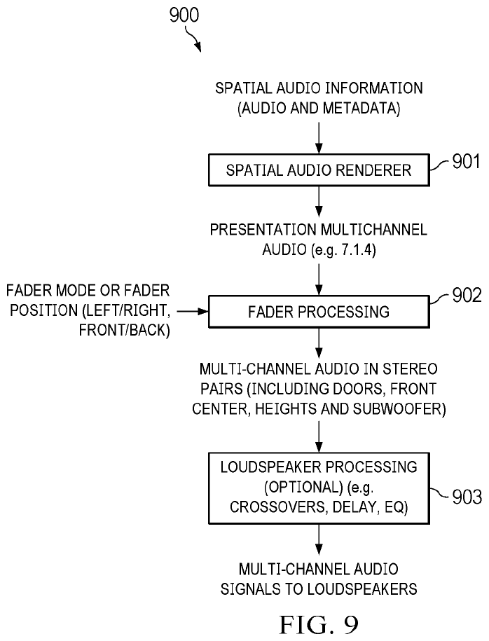

FIG. 9 is a conceptual flow diagram of an automotive audio system in a vehicle with spatial playback capabilities, including a front center loudspeaker and height loudspeakers, according to one or more embodiments. Spatial audio information comprising audio and metadata is input into spatial audio renderer 901, which generates and outputs a multichannel audio presentation (e.g., 7.1.4). The multichannel presentation is input into fading processor 902, which generates and outputs multichannel audio in stereo pairs plus height speakers and an LFE channel. The multichannel audio is input into loudspeaker processor 903 which outputs multichannel audio signals to the loudspeaker amplifiers.

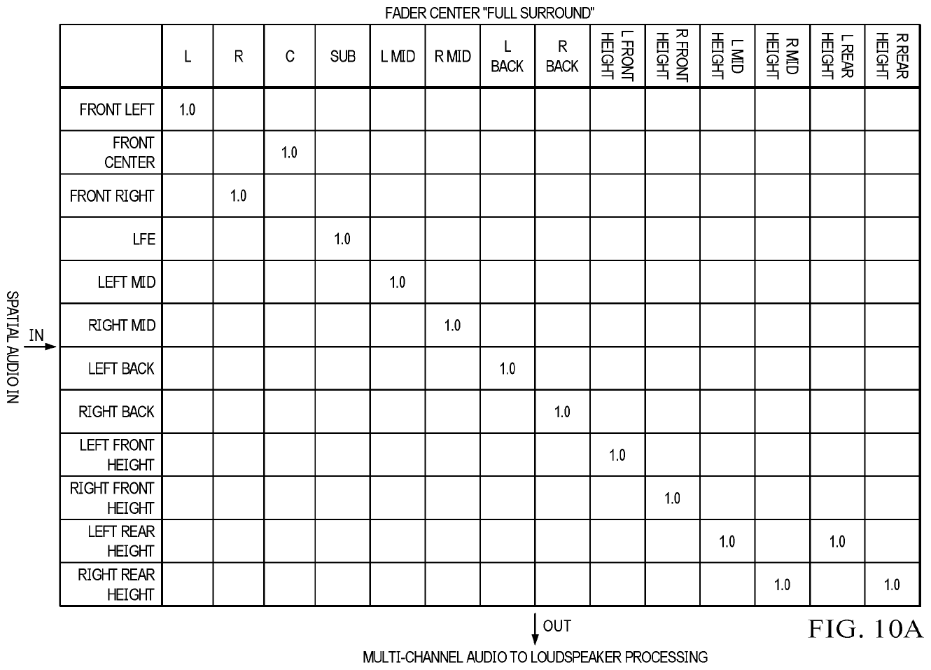

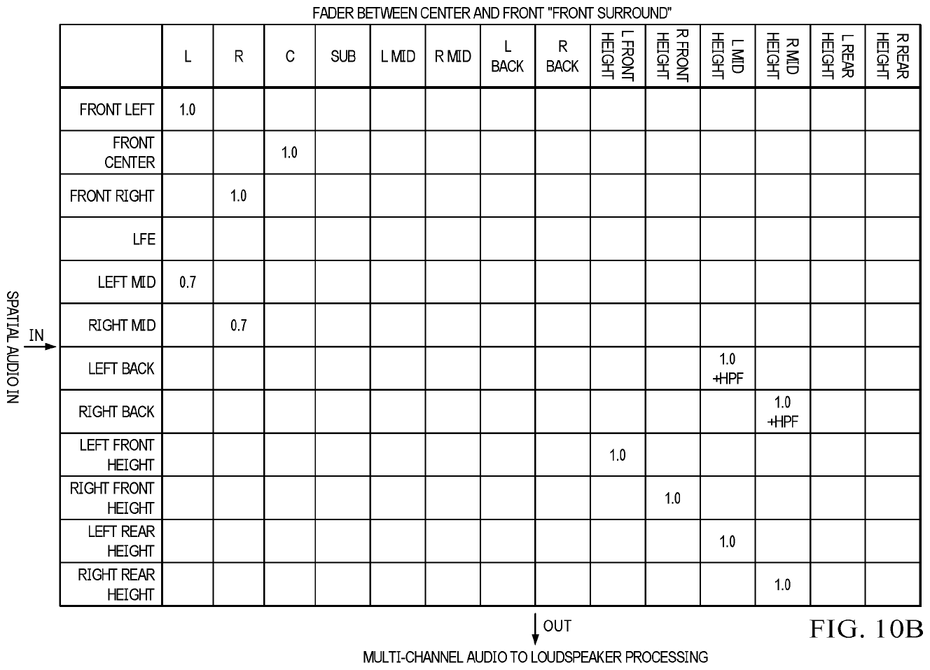

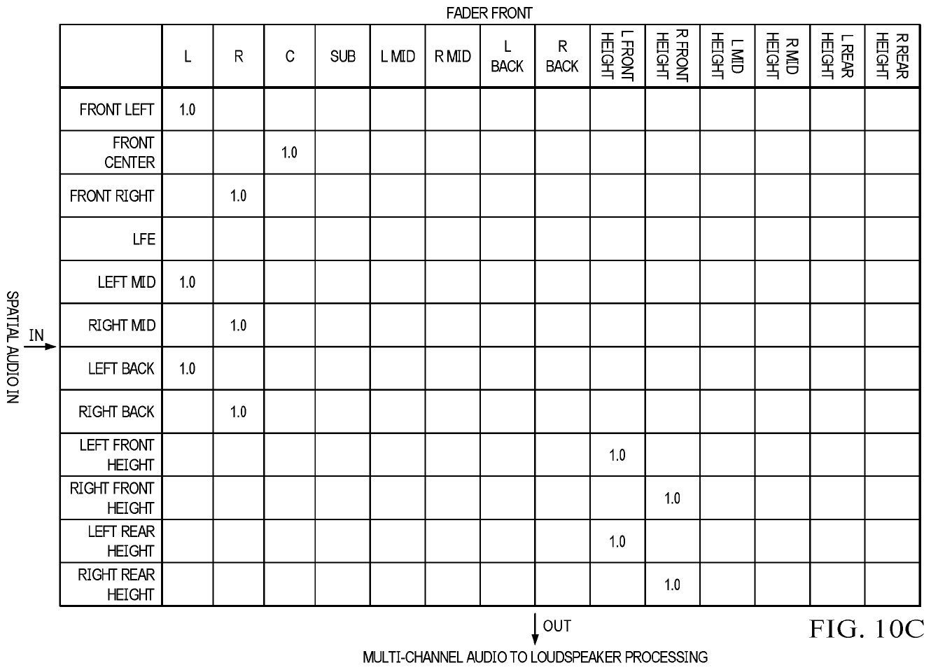

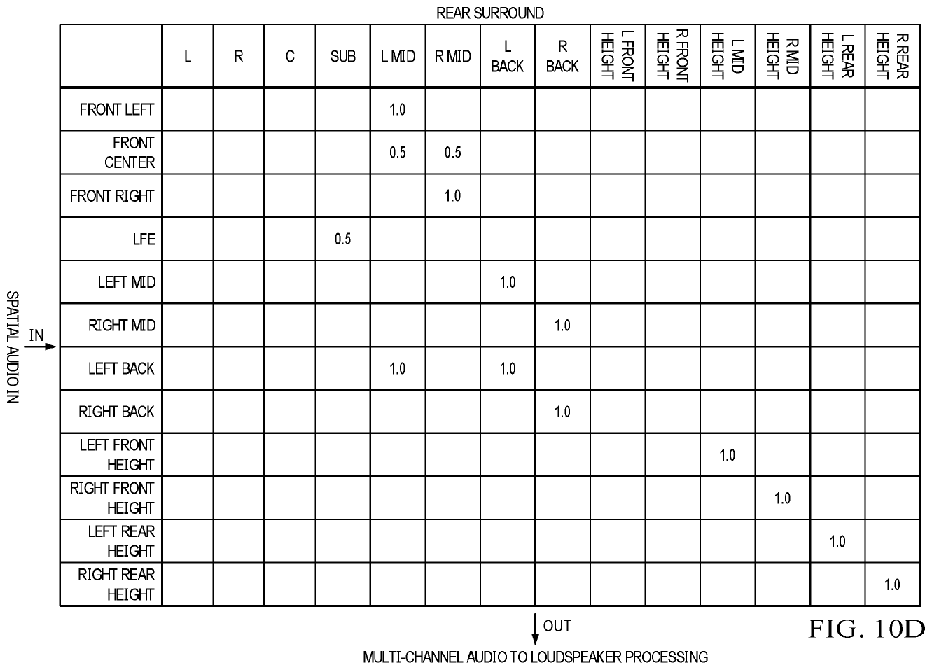

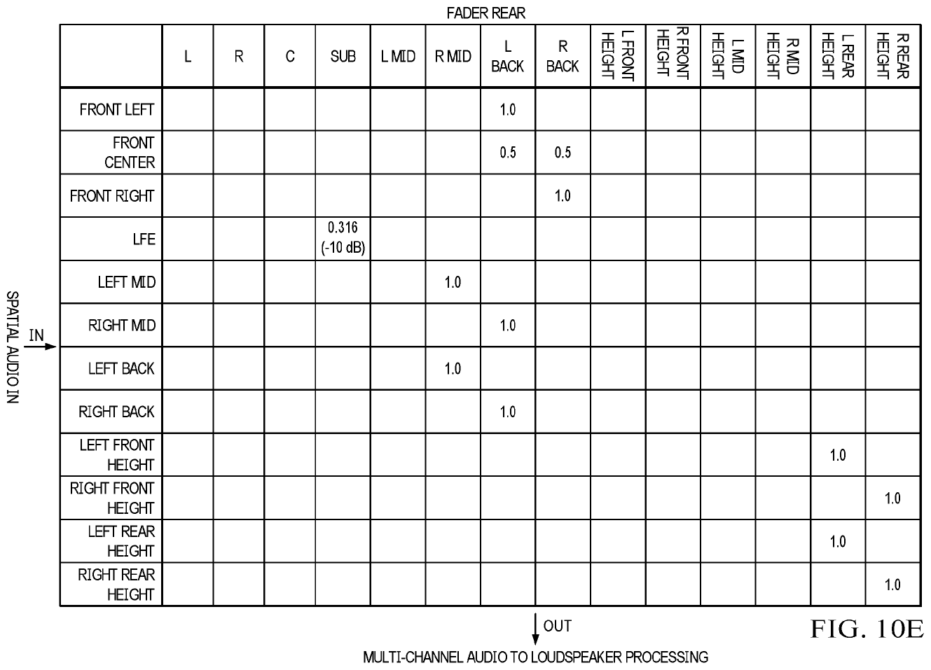

FIG. 10A shows a fader matrix for a ‘Center’ setting, according to one or more embodiments. This configuration could also be referred to herein as ‘Full Surround,’ since there is almost a 1:1 mapping between the input presentation audio channels and the output loudspeaker channels.

FIG. 10B shows a fader matrix for a fader position or mode intended to be half-way

between ‘Center’ and ‘Front’ positions, according to one or more embodiments. This configuration is hereinafter called ‘Front Surround’ since it attempts to give the front seating positions an immersive audio surround experience while making the second row quiet. Front left, front center, front right and front height presentation channels are mapped 1:1 to the corresponding output loudspeakers. Left and right mid presentation channels are mixed into the front left and front right loudspeakers and slightly attenuated, to lessen interference with the front left and right channels. The left and right rear height presentation channels are mapped into the mid height output loudspeaker position, and the left back and right back presentation channels are mapped to the left mid height and right mid height loudspeaker positions. Also, since loudspeakers typically have omnidirectionality at lower frequencies and low, and mid frequencies may be more annoying in the second seating row (where the intent is quiet), in some embodiments the left back to left mid height (and corresponding right channels) include a high-pass filter. The high pass filter provides the front seating positions some of the high frequency spatial sound (from the back presentation channels) without the annoyance of the mid and low frequencies.

FIG. 10C shows a fader matrix for a ‘Front’ fader position, according to one or more embodiments. All input presentation channels are mapped to either the front or front height loudspeaker channels. This setting loses front/back spatial aspects of the immersive sound but retains height aspects of the immersive sound and provides maximum quiet in the rear of the vehicle.

FIG. 10D shows a fader matrix for a fader position intended to be half-way between ‘Center’ and ‘Rear’ positions, according to one or more embodiments. This configuration may also be called herein as ‘Rear Surround’ since it attempts to give the rear seating positions an immersive audio surround experience while making the front row quiet.

FIG. 10E shows a fader matrix for a ‘Rear’ fader position, according to one or more embodiments. All input presentation channels are mapped to either the rear or rear height loudspeaker channels. This setting loses front/back spatial aspects of the immersive sound but retains height aspects of the immersive sound and provides maximum quiet in the front of the vehicle.

### Other Fader Positions

The previously mentioned examples show variations in front/back fader positions. Additional fader matrices could include but are not limited to left/right fading, fading to corner positions (e.g., corresponding to the driver seating position) and even fading up or down. Also, while the examples show five specific positions, finer control of fader position could be achieved with additional matrices or interpolating gain values between specific matrices, such as the ones shown. Fader matrices could also be designed to make specific seating positions quieter. For example, if the driver was on a phone call, a ‘drive on call’ matrix could attempt to reduce the level of entertainment audio at the driver seating position.

### Phantom Virtual Center Processing

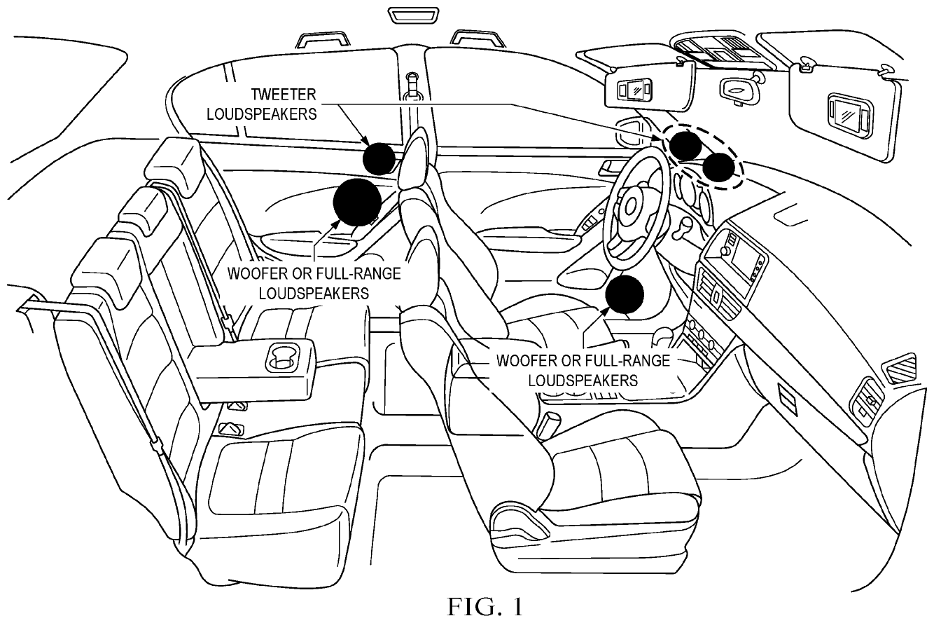

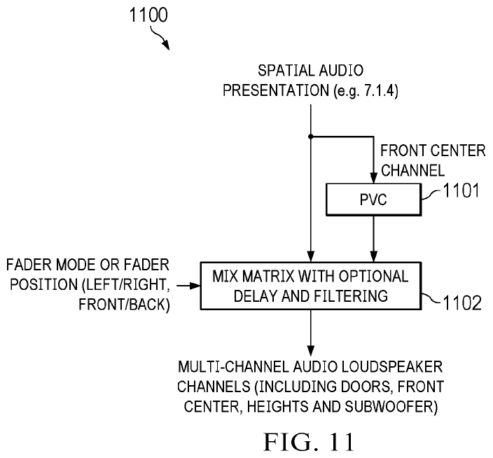

FIG. 11 illustrates a system 1100 for processing a center presentation channel with Phantom Virtual Center (PVC) technology, according to one or more embodiments. Considering again the vehicle with just stereo pairs of loudspeaker channels, as in FIG. 1, rather than mixing the center presentation channel into the left and right loudspeakers, in some embodiments it is beneficial to process the center presentation channel with PVC processor 1101. The stereo output of the PVC processing is input into mix matrix 1102, along with other presentation channels. The output of mix matrix 1102 is multichannel audio loudspeaker channels (e.g., doors, front center, height channels and LFE/subwoofer). In some embodiments, other input channel pairs, that may contain similar content, (e.g., left and right channel pairs) can be processed through additional PVC processor instances and the processor outputs provided to the mix matrix.

### Occupancy Sensing

In some embodiments, input includes occupancy data provided by vehicle systems (e.g., seat pressure sensors, interior camera). Occupancy data can include but is not limited to the number and seating locations of occupants of the vehicle. Based on this occupancy data, the multimedia audio presentation is modified or replaced with a mix that optimizes the multichannel audio experience for the listeners based on their seating locations. For example, if the occupants are sitting on the lefts side of the vehicle, then the mix can be modified to improve the perception of the audio based on their listening positions.

### Zone-Based Immersive Audio

In some embodiments, a vehicle interior is divided into two or more zones and a mix is determined based at least in part on the two or more zones. Zones can be front, back and sides of the vehicle, or divided vertically into a number of planes (e.g., bottom, horizontal and height planes). In some embodiments, the vehicle can include “quiet” zones that receive less audio levels than other parts of the vehicle interior. This can be achieved by, for example, removing/attenuating an LFE loudspeaker, or other loudspeaker(s) in the quiet zone.

### Example Process

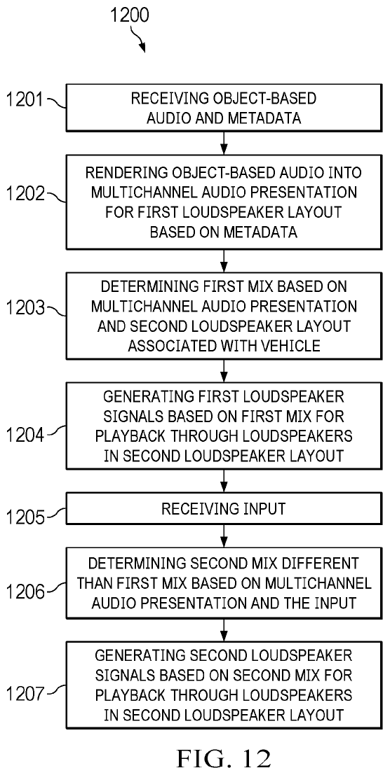

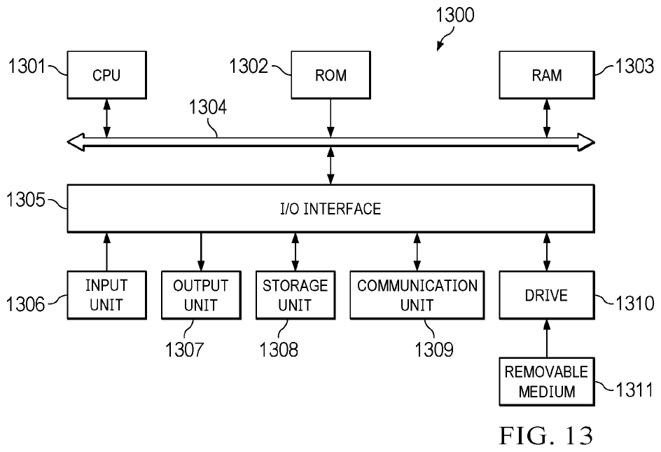

FIG. 12 is a flow diagram of VLBR Ambisonics processing, according to one or more embodiments. Process 1200 can be implemented using the electronic device architecture described in reference to FIG. 13.

Process 1200 includes: receiving object-based audio and metadata (1201); rendering the object-based audio into a multichannel audio presentation for a first loudspeaker layout based on the metadata (1202); determining a first mix based on the multichannel audio presentation and a second loudspeaker layout associated with the vehicle (1203); generating first loudspeaker signals based on the first mix for playback through loudspeakers in the second loudspeaker layout (1204); receiving input (1205); determining a second mix different than the first mix based on the multichannel audio presentation and the input (1206); and generating second loudspeaker signals based on the second mix for playback through the loudspeakers in the second loudspeaker layout (1207).

In some embodiments, the second loudspeaker layout may not correspond speaker-for-speaker with the loudspeaker layout of the vehicle (e.g., the number channels/signals associated with the second loudspeaker layout is different than the number of physical speakers in the vehicle sound system). For example, a front left channel/signal of the loudspeaker signals (e.g., post mix) could be sent to a crossover device which, based on a cutoff frequency, directs lower-frequency audio signals (e.g., LFE content) to a woofer in, e.g., a door panel of the vehicle, and higher frequency audio signals to a tweeter in, e.g., the dashboard. In such embodiments, loudspeakers signals represents a generic set of channels or signals rather than a specific set of channels or signals, each associated with a corresponding physical speaker.

In some embodiments, the first and/or second loudspeaker signals may be further processed prior to and/or after amplification before being routed to loudspeakers via loudspeaker processing 703/903 (See FIGS. 7 and 9).

In some embodiments, determining a second mix based on the first mix and the input further comprises transitioning from a first spatialization mode to a second spatialization mode, the transitioning including re-assigning portions (e.g., full signal level, attenuated signal level, full-bandwidth signal, non-full bandwidth signal) of the first loudspeaker signals to the second loudspeaker signals.

In some embodiments, the re-assigning is based in part on a distance from a listener or listening position associated with the listener, and at least one loudspeaker associated with the second speaker layout.

In some embodiments, the re-assigning moves content from loudspeakers at a first distance from a specific listener or listener position to loudspeakers at a second, and greater, distance from the specific listener or listener position.

In some embodiments, the re-assigning moves portions of the first loudspeaker signals from at least one loudspeaker in the first speaker layout at a first distance from the listener or the listener position to at least one other loudspeaker in the second speaker layout, at a second and greater distance from the listener or the listener position.

In some embodiments, reassigning is performed in accordance with a speaker performance characteristic of at least one loudspeaker associated with the second speaker layout.

In some embodiments, audio content is reassigned from a first channel to second channel in the multimedia audio presentation when a loudspeaker in the second loudspeaker layout associated with the second channel has a frequency response necessary to reproduce the re-assigned audio content from the first channel (e.g., low frequency content is assigned to loudspeakers with sufficient lower frequency response).

In some embodiments, reassigning includes reassigning portions of the first loudspeaker signals from a center channel associated with the first speaker layout to two or more second loudspeaker signals for non-center channel loudspeaker channels associated with the second speaker layout.

In some embodiments, re-assigning includes attenuating one or more portions of the second loudspeaker signals.

In some embodiments, re-assigning includes: determining a signal coherence value between audio content in portions of the first loudspeaker signals; and applying increased attenuation to the second loudspeaker signals in accordance with the coherence value exceeding one or more coherence threshold values.

In some embodiments, re-assigning includes high pass filtering at least one loudspeaker signal of the second loudspeaker signals corresponding to one or more height channels of the multimedia presentation.

In some embodiments, the multichannel audio presentation includes at least one pair of height audio channels.

### Example System Architecture

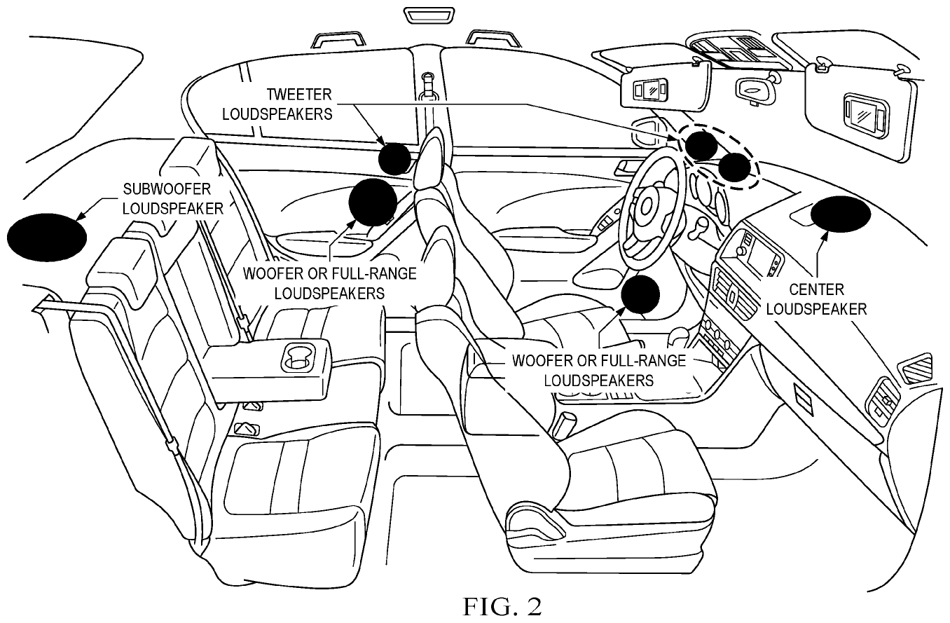

FIG. 13 shows a block diagram of an example electronic device architecture 1300 suitable for implementing example embodiments of the present disclosure. Architecture 1300 includes but is not limited to servers and client devices, as previously described in reference to FIGS. 1-6. As shown, the architecture 1300 includes central processing unit (CPU) 1301 which is capable of performing various processes in accordance with a program stored in, for example, read only memory (ROM) 1302 or a program loaded from, for example, storage unit 1308 to random access memory (RAM) 1303. In RAM 1303, the data required when CPU 1301 performs the various processes is also stored, as required. CPU 1301, ROM 1302 and RAM 1303 are connected to one another via bus 804. Input/output (I/O) interface 1305 is also connected to bus 1304.

The following components are connected to I/O interface 1305: input unit 1306, that may include a keyboard, a mouse, or the like; output unit 1307 that may include a display such as a liquid crystal display (LCD) and one or more speakers; storage unit 1308 including a hard disk, or another suitable storage device; and communication unit 1309 including a network interface card such as a network card (e.g., wired or wireless).

In some implementations, input unit 1306 includes one or more microphones in different positions (depending on the host device) enabling capture of audio signals in various formats (e.g., mono, stereo, spatial, immersive, and other suitable formats).

In some implementations, output unit 1307 include systems with various number of speakers. Output unit 1307 (depending on the capabilities of the host device) can render audio signals in various formats (e.g., mono, stereo, immersive, binaural, and other suitable formats). In some embodiments, communication unit 1309 is configured to communicate with other devices (e.g., via a network). Drive 1310 is also connected to I/O interface 1305, as required. Removable medium 1311, such as a magnetic disk, an optical disk, a magneto-optical disk, a flash drive or another suitable removable medium is mounted on drive 1310, so that a computer program read therefrom is installed into storage unit 1308, as required. A person skilled in the art would understand that although system 1300 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine-readable medium, the computer program including program code for performing methods. In such embodiments, the computer program may be downloaded and mounted from the network via the communication unit 1309, and/or installed from the removable medium 1311, as shown in FIG. 13.

Generally, various example embodiments of the present disclosure may be implemented in hardware or special purpose circuits (e.g., control circuitry), software, logic, or any combination thereof. For example, the units discussed above can be executed by control circuitry (e.g., CPU 1301 in combination with other components of FIG. 13), thus, the control circuitry may be performing the actions described in this disclosure. Some aspects may be implemented in hardware, while other aspects may be implemented in firmware or software which may be executed by a controller, microprocessor or other computing device (e.g., control circuitry). While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may be non-transitory and may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

While this document contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

### Example Embodiments

EE1. A method comprising: at an electronic device comprising a user input device and a second subset of loudspeakers of a second speaker type different than the first speaker type (e.g., height plane speakers, height speakers, near-field speakers, etc.), the set of loudspeakers arranged in a device speaker layout within an enclosed volume (e.g., a listening environment, a vehicle cabin, a room, a theater, a gaming venue, etc., with loudspeakers affixed about the enclosed volume): receiving audio program content as a first set of audio signals in a format corresponding to a presentation layout (e.g., a set of audio channel signals corresponding to a predetermined channel layout, for example, 9.1.6, 9.1.4, 9.1.2, 7.1.6, 7.1.4, 7.1.2, 5.1.6, 5.1.4, 5.1.2); generating, based on the first set of audio signals, a second set of audio signals corresponding to the set of loudspeakers (e.g., a set of speaker audio signals corresponding the device speaker layout), the second set of audio signals having a number of audio signals equal to the quantity of the same number of loudspeakers in the set of loudspeakers using a first set of gains; providing the second set of audio signals or signals derived from the second set of audio signals to the set of loudspeakers causing the set of loudspeakers to generate acoustic output spatializing the audio program content represented by the first set of audio signals; receiving a sequence of one or more user inputs at the user input device corresponding to a request to spatially modify the acoustic output; and in response to receiving the sequence of one or more user inputs, transitioning electronic device operation from a first spatialization mode to operation in a second spatialization mode by: generating, from the first set of audio signals, a third set of audio signals corresponding to the set of loudspeakers (e.g., speaker audio signals including modified spatial qualities) using a second set of gains different than the first set of gains; and providing the third set of audio signals or signals derived from the third set of audio signals to the set of loudspeakers causing the set of loudspeakers to generate acoustic output spatializing the audio program content represented by the first set of audio signals with modified spatial characteristics.

In some embodiments, a user input device is a touchscreen or touch sensitive surface, a physical/mechanical control such as a knob, a dial, a slider, a button, a rotatable and depressible input device, a voice input device, etc.) and a set of loudspeakers including a first subset of loudspeakers of a first speaker type (e.g., horizontal plane speakers, non-height speakers, far-field speakers, etc.).

In some embodiments, the electronic device is a vehicle, media playback device, an infotainment system, a head unit, a multi-function device (e.g., a phone, tablet) coupled to a media playback system, etc.

In some embodiments, the presentation layout is different from the device speaker layout.

In some embodiments, the predetermined speaker layout is the same as the device speaker layout.

In some embodiments, the first set of gains is a matrix of gains corresponding to default spatialization operating mode or spatialization setting.

In some embodiment, a set of signals is derived by further processing (e.g., applying downmixing or equalization and/or amplifying the resulting signals) to drive the amplifiers of the loudspeakers.

EE2. Any of the methods disclosed herein, wherein the first speaker type is a non-height speaker type or a horizontal plane speaker type (e.g., a speaker mounted and aimed to direct acoustic output toward an intended listening position (directly or via reflection) from below height plane speakers or from below or co-planar to an intended listening position).

EE3. Any of the methods disclosed herein, wherein the second speaker type is a height

speaker type or a height plane speaker type (e.g., a speaker mounted and aimed to direct acoustic output toward an intended listening position (directly or via reflection) from above the horizontal plane speakers or from above an intended listening position).

EE4. Any of the methods disclosed herein, wherein the first speaker type is a far-field speaker type.

EE5. Any of the methods disclosed herein, wherein the second speaker type is a near-field speaker type.

EE6. Any of the methods disclosed herein, wherein the set of loudspeakers includes one or more dedicated low frequency loudspeakers. In some embodiments, low frequency loudspeakers include subwoofers, bass shakers, force transducers, tactile transducers, or other low-frequency optimized transducers.

EE7. Any of the methods disclosed herein, wherein the first set of audio signals includes one or more pairs of height audio channels.

EE8. Any of the methods disclosed herein, wherein the first set of audio signals corresponds to a speaker format selected from the set of: 9.1.6, 9.1.4, 9.1.2, 7.1.6, 7.1.4, 7.1.2, 5.1.6, 5.1.4, and 5.1.2.

EE9. Any of the methods disclosed herein, further comprising: prior to receiving audio program content as a first set of audio signals: receiving object-based audio representing the audio program content, the object-based audio including a set of one or more sound source essence signals with corresponding information (e.g., metadata) indicating spatial characteristics of a respective sound source; and rendering the object-based audio, with an object renderer, into the first set of audio signals in the format corresponding to the presentation layout.

EE10. Any of the methods disclosed herein, wherein spatial characteristics includes at least one selected from the set of a location of a respective source in 3-dimensional space relative to a listener position, a size or level of dispersion of a respective source, and a distance of a respective source from a listener position. In some embodiments, object-based audio is a media program, a music or video program, a sound data associated with operation of a non-entertainment system (e.g., safety notification), etc.) In some embodiments, object-based audio is stored locally as a complete file or is received sequentially via a streaming protocol.

EE12. Any of the methods disclosed herein, wherein the second set of gains are generated from the first set of gains and a third set of gains that is different than the first set of gains and different from the second set of gains.

EE13. Any of the methods disclosed herein, wherein transitioning electronic device operation from a first spatialization mode to operation in a second spatialization mode includes re-assigning portions (e.g., full signal level, attenuated signal level, full-bandwidth signal, non-full bandwidth signal) of the first set of audio signals from a channel or signal associated with the presentation layout to a non-corresponding channel or set of signals associated with the device speaker layout.

EE14. Any of the methods disclosed herein, wherein re-assigning is based in part on a distance from a listener or a seating position associated with a listener and at least one of the set of loudspeakers arranged in the device speaker layout within the enclosed volume. In some embodiments, re-assigning moves content from loudspeakers at a first distance from a specific listener or listener position to loudspeakers at a second, and greater, distance from the specific listener or listener position.

EE15. Any of the methods disclosed herein, wherein reassigning is performed in accordance with a speaker performance characteristic of at least one of the set of loudspeakers arranged in a device speaker layout within the enclosed volume. In some embodiments, content is reassigned from a first channel to second channel when the loudspeaker associated with the second channel has a frequency response necessary to reproduce the re-assigned content from the first channel (e.g., low frequency content is only assigned to loudspeakers with sufficient lower frequency response).

EE16. Any of the methods disclosed herein, wherein reassigning includes reassigning portions of the first set of audio signals from a center channel of the presentation layout to two or more non-center channel loudspeaker channels associated in the device speaker layout.

EE17. Any of the methods disclosed herein, wherein re-assigning includes attenuating one or more portions of the first set of audio signals.

EE18. Any of the methods disclosed herein, wherein re-assigning includes determining a signal coherence value between content in portions of the first set of audio signals; and applying increased attenuation in accordance with the coherence value exceeding one or more coherence threshold values.

EE19. Any of the methods disclosed herein, wherein re-assigning includes high pass filtering one audio signals of the first set of audio signals corresponding to one or more height channels of the presentation layout.

EE20. Any of the methods disclosed herein, wherein providing the third set of audio signals or signals derived from the third set of audio signals to the set of loudspeakers cause a local sound field at a first listening position in the enclosed volume to have reduced acoustic output (e.g., sound pressure, perceptually weighted or absolute) relative to the acoustic output produced by providing the second set of audio signals or signals derived from the second set of audio signals to the loudspeakers, while maintaining spatialization (e.g., perceived height effects varying with metadata in source signals) within a local sound field at least a second listening position in the enclosed volume.

EE21. Any of the methods disclosed herein, wherein the second or third set of audio signals include one or more pairs of height audio channels.

EE22. Any of the methods disclosed herein, wherein the second or third set of audio signals corresponds to a speaker format selected from the set of: 9.1.6, 9.1.4, 9.1.2, 7.1.6, 7.1.4, 7.1.2, 5.1.6, 5.1.4, and 5.1.2.

EE23. Any of the methods disclosed herein, wherein the second or third set of audio signals corresponds to a speaker format that does not includes height channels.

EE24. Any of the methods disclosed herein, wherein the enclosed volume includes seats arranged in a first row of listening or seating positions.

EE25. Any of the methods disclosed herein, wherein the second subset of loudspeakers includes a first pair of height speakers mounted and aimed to direct acoustic output (i) from locations in front of the first row and (ii) from locations above the first subset of speakers, towards a listening position at a location corresponding to the first row of listening or seating positions.

EE26. Any of the methods disclosed herein, wherein the enclosed volume includes a second row of listening or seating positions located behind the first row of listening or seating positions.

EE27. Any of the methods disclosed herein, the second subset of loudspeakers includes a second pair of height speakers mounted and aimed to direct acoustic output (i) from positions behind the first row of listening or seating positions and/or (ii) from positions in front of the second row of listening or seating positions, (iii) from positions above each of the first subset of speakers, and (iv) towards a listening position at a location corresponding to the second row of listening or seating positions.

EE28. Any of the methods disclosed herein wherein, the enclosed volume includes a third row of listening or seating positions located behind the second row of listening or seating positions.

EE29. Any of the methods disclosed herein wherein, the second subset of loudspeakers includes a third pair of height speakers mounted and aimed to direct acoustic output (i) from above the first subset of speakers and (ii) from behind the second row. In some embodiments, the third pair of height speakers are mounted at position on a rear interior deck, a C-pillar, or a D-pillar of an automobile cabin. In some embodiments, the height speakers are designed to reflect sound off a surface in a downward direction towards a listener in a seating position. In some embodiments, the height speakers are mounted above first subset of speakers.

EE30 Any of the methods disclosed herein, further comprising: after generating the second set of audio signals or after generating the third set of audio signals, and prior to providing the respective audio signals to the set of loudspeakers, processing the respective audio signals to compensate for one or more of: speaker location, speaker response, absorptive and reflective properties of nearby materials within the enclosed volume, hearing sensitivity of occupants or listeners positioned within the enclosed volume. In some embodiments, processing includes time alignment (e.g., based distance to one or more listeners or seating positions), active or passive filtering, etc.

What is claimed is:

1. A method comprising:
receiving, with at least one processor of an audio system, object-based audio and metadata;
rendering, with the at least one processor, the object-based audio into a multichannel audio presentation for a first loudspeaker layout based on the metadata;
generating, with the at least one processor, a first mix by applying a first mapping of the multichannel audio presentation to a second loudspeaker layout associated with a vehicle;
generating, with the at least one processor, first loudspeaker signals based on the first mix for playback through loudspeakers in the second loudspeaker layout;
receiving, with the at least one processor, input;
generating, with the at least one processor, a second mix different from the first mix by applying a second mapping of the multichannel audio presentation to the second loudspeaker layout associated with the vehicle, the second mapping based on the input; and
generating, with the at least one processor, second loudspeaker signals based on the second mix for playback through the loudspeakers in the second loudspeaker layout.

2. (canceled)

3. (canceled)

4. The method of claim 1, wherein the input includes a fader position of a fader control of the audio system.

5. The method of claim 1, wherein the input includes a fader mode that indicates a preset modification to the multichannel audio presentation.

6. The method of claim 1, wherein the input relates to occupancy data indicating a number of occupants in the vehicle and their seating locations in the interior of the vehicle.

7. The method of claim 1, wherein the vehicle includes an interior divided into two or more zones and the second mix is determined based at least in part on the two or more zones.

8. The method of claim 1, wherein the second mix applies a gain to at least one channel of the multichannel audio presentation, and wherein the gain is included in a set of gains that maps channels in the multichannel audio presentation to the loudspeakers in the second loudspeaker layout.

9. (canceled)

10. (canceled)

11. The method of claim 1, wherein the second loudspeaker layout includes left/right front loudspeakers and left/right back loudspeakers, and the multichannel audio presentation includes left/right/center loudspeakers, left/right middle loudspeakers, and left/right back loudspeakers.

12. The method of claim 1, wherein the second loudspeaker layout further includes at least one of: left/right front height loudspeakers and left/right back height loudspeakers.

13. (canceled)

14. (canceled)

15. The method of claim 1, wherein the number of channels in the multichannel audio presentation is less than the number of loudspeakers in the second loudspeaker layout.

16. (canceled)

17. The method of claim 1, wherein the multichannel audio presentation includes spatial positions or directions for the loudspeakers in a horizontal plane and a height plane.

18. The method of claim 1, wherein the second mix applies delay or filtering to the second loudspeaker signals.

19. The method of claim 1, wherein determining a second mix based on the multichannel audio presentation and the input further comprises transitioning from a first spatialization mode to a second spatialization mode, the transitioning including re-assigning portions of the first loudspeaker signals to the second loudspeaker signals.

20. The method of claim 19, wherein the re-assigning is based in part on a distance from a listener or listening position associated with the listener, and at least one loudspeaker associated with the second speaker layout.

21. The method of claim 19, wherein the re-assigning moves portions of the first loudspeaker signals from at least one loudspeaker in the second speaker layout at a first distance from the listener or the listener position to at least one other loudspeaker in the second speaker layout, at a second and greater distance from the listener or the listener position.

22. The method of claim 19, wherein reassigning is performed in accordance with a speaker performance characteristic of at least one loudspeaker in the second speaker layout.

23. The method of claim 19, wherein reassigning includes reassigning portions of the first loudspeaker signals from a center channel associated with the first speaker layout to two or more second loudspeaker signals for non-center channel loudspeaker channels associated with the second speaker layout.

24. The method of claim 19, wherein re-assigning includes attenuating one or more portions of the second loudspeaker signals.

25. (canceled)

26. The method of claim 19, wherein re-assigning includes high pass filtering at least one loudspeaker signal of the second loudspeaker signals corresponding to one or more height channels of the multichannel audio presentation.

27. (canceled)

28. An audio playback system, comprising:
an audio fader control;
at least one processor;
memory storing instructions that when executed by the at least one processor, cause the at least one processor to perform operations comprising:
receiving object-based audio and metadata;
rendering the object-based audio into a multichannel audio presentation for a first loudspeaker layout based on the metadata;
generating a first mix by applying a first mapping of the multichannel audio presentation to a second loudspeaker layout;
generating first loudspeaker signals based on the first mix for playback through loudspeakers in the second loudspeaker layout;
receiving input through the audio fader control;
generating a second mix different from the first mix by applying a second mapping of the multichannel audio presentation to the second loudspeaker layout, the second mapping based on the input; and
generating, with the at least one processor, second loudspeaker signals based on the second mix for playback through the loudspeakers in the second loudspeaker layout.

29. A non-transitory, computer-readable storage medium including instructions thereon that, when executed by at least one processor of an electronic device with a fader control, cause the at least one processor to perform operations comprising:
receiving object-based audio and metadata;
rendering the object-based audio into a multichannel audio presentation for a first loudspeaker layout based on the metadata;
generating a first mix by applying a first mapping of the multichannel audio presentation to a second loudspeaker layout;
generating first loudspeaker signals based on the first mix for playback through loudspeakers in the second loudspeaker layout;
receiving input through the audio fader control;
generating a second mix different from the first mix by applying a second mapping of the multichannel audio presentation to the second loudspeaker layout, the second mapping based on the input; and
generating, with the at least one processor, second loudspeaker signals based on the second mix for playback through the loudspeakers in the second loudspeaker layout.
